(19) United States
(12) Patent Application Publication
(10) Pub. No.: US 2026/0093524 A1
(43) Pub. Date: Apr. 2, 2026

(54) SCALING MANAGEMENT IN A DISTRIBUTED COMPUTING ENVIRONMENT

(71) Applicant: Honeywell International Inc., Charlotte, NC (US)

(72) Inventors: Faizan Bashir Teli, Srinagar (IN); McMillan Goyal, Bengaluru (IN); Debabrata Palai, Atlanta, GA (US); Sham Sharma, Atlanta, GA (US)

(21) Appl. No.: 18/903,174

(22) Filed: Oct. 1, 2024

(51) Int. Cl. G06F 9/48

(52) U.S. Cl. CPC G06F 9/4881

(57) ABSTRACT

Devices, methods, and systems for scaling management in a distributed computing environment are described herein. One method includes determining a status of a pod running a workload in distributed computing environment, where the pod is an object in the distributed computing environment having a number of containers to execute computer-readable instructions to run the workload, determining whether an exemption exists for the workload, and scaling the distributed computing environment for the workload based on the status of the pod and whether the exemption exists for the workload, where scaling the distributed computing environment for the workload includes creating a number of replicas of the pod to additionally run the workload.

### TECHNICAL FIELD

The present disclosure relates generally to devices, methods, and systems for scaling management in a distributed computing environment.

### BACKGROUND

A distributed computing environment can include various computing resources. Such computing resources can be comprised of computing systems having inter-communicating components which can be located on different networked computing systems. The computing resources in the distributed computing environment and/or other services may be provisioned in order to deploy workloads.

A distributed computing environment may be utilized to deploy a particular workload requested by a client. For instance, computing resources in a cloud infrastructure, private data center, and/or bare metal servers may be examples of distributed computing environments utilized to deploy a particular workload, among other computing resource environments.

### BRIEF DESCRIPTION OF THE DRAWINGS

FIG. 1 illustrates a block diagram of an example of a system for scaling management in a distributed computing environment in accordance with one or more embodiments.

FIG. 2 illustrates an example of a method for scaling a workflow in a distributed computing environment in accordance with one or more embodiments.

FIG. 3 is an example of a method for scaling management in a distributed computing environment, in accordance with one or more embodiments.

FIG. 4 is an example of a computing device for scaling management in a distributed computing environment in accordance with one or more embodiments.

### DETAILED DESCRIPTION

Devices, methods, and systems for scaling management in a distributed computing environment are described herein. One method includes determining a status of a pod running a workload in distributed computing environment, where the pod is an object in the distributed computing environment having a number of containers to execute computer-readable instructions to run the workload, determining whether an exemption exists for the workload, and scaling the distributed computing environment for the workload based on the status of the pod and whether the exemption exists for the workload, where scaling the distributed computing environment for the workload includes creating a number of replicas of the pod to additionally run the workload.

As mentioned above, a distributed computing environment may be utilized to deploy a workload. A workload can be, for example, a set of computational tasks. For example, a workload can include an application, service, or other set of computational tasks that can be run using computing resources provisioned from the distributed computing environment.

A distributed computing environment may be shared by multiple different workloads. For example, multiple users may provision different computing resources within the distributed computing environment to deploy different workloads using the distributed computing environment.

However, there may be times at which the computing resources in the distributed computing environment are not efficiently provisioned. For example, there may be certain workloads that are over-provisioned with computing resources, where these workloads do not utilize the full extent of their computing resources. This may result in other workloads that may need additional computing resources that are unavailable.

Scaling management sequences in a distributed computing environment, as described herein, can be utilized to make real-time, intelligent scaling decisions to allow for efficient scaling of computing resources in a distributed computing environment without putting an undue load on the distributed computing environment. The scaling decisions can be based on events and annotations associated with pods of the distributed computing environment, and may be time-based. For instance, there may be times when certain workloads may need additional computing resources within the distributed computing environment, and computing resources can be scaled within the distributed computing environment according to a scaling sequence. The scaling sequence can allow for scaling computing resources for a predetermined period of time according to a time-based exemption for the workload, allowing for such workloads to receive additional computing resources for a specified period of time. Further, the scaling sequence can include a tamper-proof annotation synchronization mechanism.

For example, the status of a pod (e.g., an object in the distributed computing environment) running a workload in the distributed computing environment can be monitored to determine a resource usage of the pod for the workload, and the scaling sequence can be performed based on the current status of the pod within the distributed computing environment running the workload and whether a time-based exemption exists for the workload. If the time-based exemption exists and the status of the pod running the workload indicates the resource usage for the workload exceeds a threshold, the distributed computing environment can be scaled for the workload by creating replicas of the pod to additionally run the workload. Utilizing time-based exemptions to enable scaling allows for accurate, efficient, and fair resource allocation among users running workloads in the distributed computing environment.

Upon expiration of the period of time for the time-based exemption, the distributed computing environment can be scaled down by deleting the plurality of replicas. If no time-based exemption exists for the workload, then no scaling actions are performed.

Additionally, a synchronization process can occur to ensure annotations associated with a pod have not been tampered with. For instance, the synchronization can include comparing an annotation associated with the pod with annotation information in a database to ensure the annotation associated with the pod has not been tampered with. The synchronization process can ensure that tampering within the distributed computing environment has not occurred.

Such an approach can prevent computing resources in the distributed computing environment from being monopolized, ensuring fair resource allocation across the distributed computing environment and preventing computing resource shortages for other workloads. Accordingly, by ensuring fair and efficient computing resource utilization, scaling management in a distributed computing environment can provide better performance and reliability in the distributed computing environment, as compared with previous approaches.

In the following detailed description, reference is made to the accompanying drawings that form a part hereof. The drawings show by way of illustration how one or more embodiments of the disclosure may be practiced.

These embodiments are described in sufficient detail to enable those of ordinary skill in the art to practice one or more embodiments of this disclosure. It is to be understood that other embodiments may be utilized and that mechanical, electrical, and/or process changes may be made without departing from the scope of the present disclosure.

As will be appreciated, elements shown in the various embodiments herein can be added, exchanged, combined, and/or eliminated so as to provide a number of additional embodiments of the present disclosure. The proportion and the relative scale of the elements provided in the figures are intended to illustrate the embodiments of the present disclosure and should not be taken in a limiting sense.

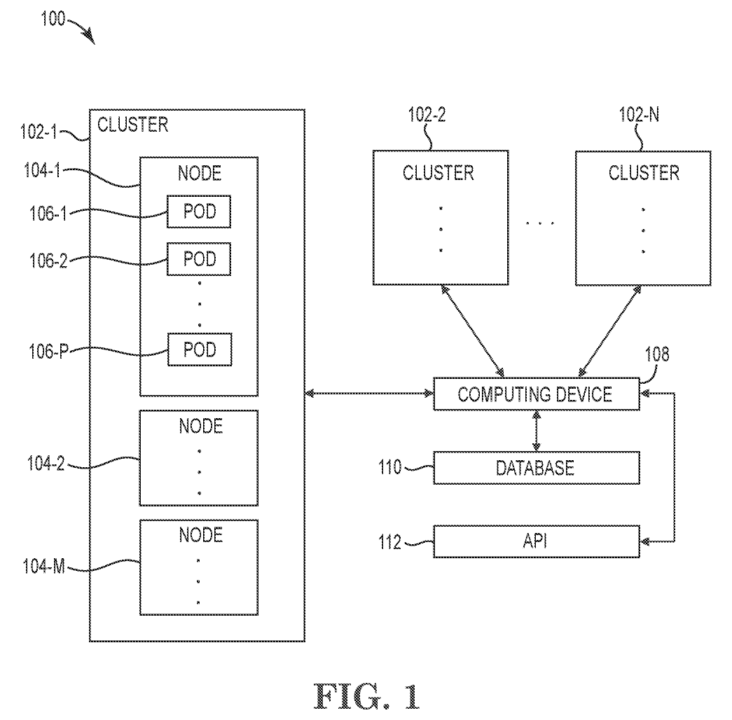

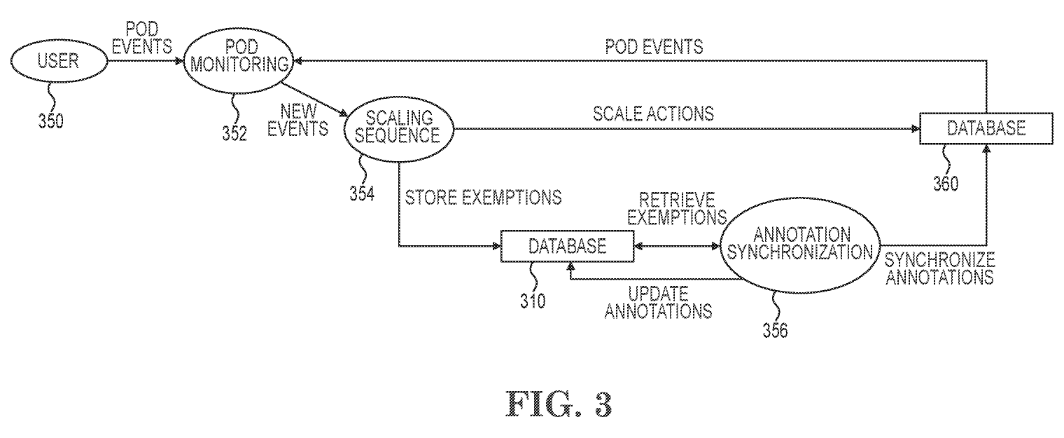

The figures herein follow a numbering convention in which the first digit or digits correspond to the drawing figure number and the remaining digits identify an element or component in the drawing. Similar elements or components between different figures may be identified by the use of similar digits. For example, 108 may reference element “08” in FIG. 1, and a similar element may be referenced as 308 in FIG. 3.

As used herein, “a”, “an”, or “a number of” something can refer to one or more such things, while “a plurality of” something can refer to more than one such things. For example, “a number of components” can refer to one or more components, while “a plurality of components” can refer to more than one component.

FIG. 1 illustrates a block diagram of an example of a system 100 for scaling management in a distributed computing environment in accordance with one or more embodiments. The system 100 can include clusters 102-1, 102-2,…, 102-N, a computing device 108, a database 110, and an application programming interface (API) 112.

As mentioned above, a distributed computing environment may be utilized to deploy a workload or multiple workloads. Such a distributed computing environment can be represented by the system 100 illustrated in FIG. 1. For example, the system 100 can be a distributed computing environment that can operate to deploy various workloads within the system 100. Examples of workloads can include executing applications or services, hosting databases, processing of data, etc.

The distributed computing environment of the system 100 can be, for example, a Kubernetes environment. A Kubernetes environment can be, for example, a computing orchestration system for workload deployment, scaling, and management.

The system 100 can include clusters 102-1, 102-2,…, 102-N. As used herein, a cluster refers to a set of containerized nodes configured to run computing workloads and/or services. For example, as illustrated in FIG. 1, the cluster 102-1 can include nodes 104-1, 104-2, 104-M. As used herein, a node refers to a computing resource that is configured to run a workload. The nodes 104-1, 104-2, 104-M can be, for example, physical machines or virtual machines that can run workloads within the cluster 102-1.

Within the nodes 104-1, 104-2,…, 104-M, the system 100 can further include pods 106-1, 106-2, …, 106-P. As used herein, a pod refers to a cluster deployment unit that includes one or more containers. A container refers to a self-contained software package including everything to run an application, such as code, runtime, application and system libraries, default values for settings, etc. For example, a workload can be run on a pod 106-1 of a node 104-1 included in a cluster 102-1 in a Kubernetes environment as illustrated in the system 100 of FIG. 1.

As mentioned above, examples of workloads can include executing applications or services, hosting databases, processing of data, etc. One example of a workload in the system 100 can include processing of telemetry data. A building may include various sensors within the building system, such as fire sensors, smoke sensors, intrusion and/or access sensors, monitoring sensors, closed circuit television (CCTV), among others, which can capture information which can be stored as data. Such data may be transmitted to the system 100 for processing and/or analysis. For example, data from smoke sensors in a building may be transmitted to the system 100 for processing and/or analysis as a workload by pod 106-1.

Although a workload is described above as including processing and/or analysis of telemetry data from a building management system, embodiments are not so limited. For instance, as another example, an airport may generate data related to flight management systems, airport weather stations, air traffic control information, etc. Such data may be transmitted to the system 100 as a workload by pod 106-P for processing and/or analysis. Accordingly, workloads can varied and diverse, ranging across many different types of industries.

As illustrated in FIG. 1, the system 100 further includes a database 110. The database 110 can be, for example, a PostgreSQL database operating within the Kubernetes environment. The database 110 can include (e.g., be a collection of) data associated with scaling sequences described herein.

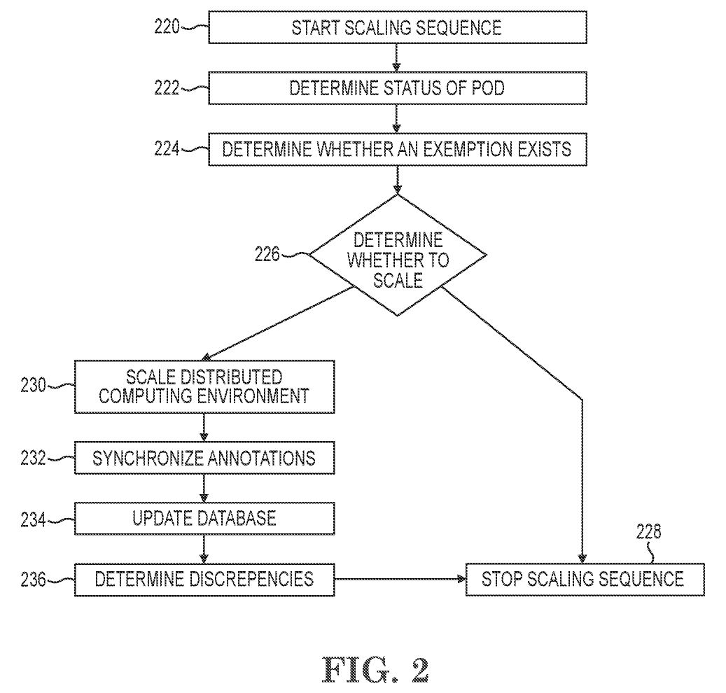

Additionally, the system 100 can further include an API 112. The API 112 can be an interface for various computing applications to communicate with each other. For example, the API 112 can receive exemption requests for workloads, as is further described in connection with FIG. 2.

As mentioned above, some workloads may need additional computing resources within the distributed computing environment. For instance, in an example in which a flight management system runs as a workload on pod 106-1, the workload may be tested to ensure that the pod 106-1 is able to run the workload associated with the flight management system. The testing may occur over a weekend, may need multiple days, etc. The computing device 108 can cause a scaling process to occur to provide additional computing resources for the workload, according to a status of the pod 106-1 running the workload and whether an exemption exists for the pod 106-1, as is further described in connection with FIG. 2.

FIG. 2 illustrates an example of a method for scaling a workflow in a distributed computing environment in accordance with one or more embodiments. The method can be performed by, for example, computing device 108 of the distributed computing environment, previously described in connection with FIG. 1.

As previously mentioned in connection with FIG. 1, the computing device can cause a scaling sequence to occur. For example, at 220, the method includes starting a scaling sequence by the computing device. The scaling sequence can determine whether to scale the distributed computing environment for a workload, as is further described herein.

Initially, the computing device can determine, at 222, a status of a pod running a workload in the distributed computing environment. Determining a status of a pod can include determining a resource usage of the pod, checking an annotation associated with the pod, and determining a deployment of the pod, a stateful set of the pod, and/or a deployment configuration of the pod, as is further described herein.

As previously described in connection with FIG. 1, a pod can be a cluster deployment unit that includes one or more containers. For example, the pod can be an object in the distributed computing environment having a number of containers. The number of containers can be configured to execute computer-readable instructions to run a workload. The computer-readable instructions can be, for instance, code, runtime, application and system libraries, default values for settings, etc. As one example, the number of containers can be configured to execute computer-readable instructions to run a flight management system on a pod, and the computing device can utilize the method described herein to determine whether the distributed computing environment should be scaled to run the flight management system.

At 222, the method includes determining the status of the pod by determining a resource usage of the pod for the workload. Resource types used by the pod can include compute processing unit (CPU) and memory resources. The computing device can determine, for example, the resource usage for the pod to be 1 CPU and 260 mebibytes (MiB) of memory. The resource usage may be a resource usage determined at a particular moment in time, an average resource usage over a specified period of time, etc.

Although the resource types are described above as including CPU and memory, embodiments are not so limited. For example, the computing device can determine usage of other suitable resource types for the pod in the distributed computing environment.

Additionally, determining the status of the pod can include checking an annotation associated with the pod. An annotation includes metadata associated with the pod that describes exemption related information about the pod. For example, the pod can include an annotation attached to the pod in the form of metadata and can include an exempt status of the pod, a maximum number of replicas allowed for an exemption for the pod, a period of time for an exemption for the pod, and/or contact information for a user associated with the pod, among other information.

For example, the annotation associated with the pod running the flight management system as the workload can include an exempt status of exempt, a maximum number of replicas for an exemption of 8, a period of time for an exemption of 2 days, and contact information for the user associated with the pod (e.g., a business unit, team, project, and/or actual name of a user associated with one of the above listed groups, etc.).

Further, determining the status of the pod can include determining a deployment of the pod, a stateful set of the pod, and/or a deployment configuration of the pod. The deployment of the pod can include a deployment state such as pending, running, succeeded, failed, etc. The stateful set of the pod can include identifiers, sticky storage, and/or automated rolling updates about how the pod may be affected by scaling. Additionally, the deployment configuration of the pod can include a desired state of the pod during deployment and/or a point-in-time record of a state of the deployment of the pod.

At 224, the method includes determining whether an exemption exists for the workload. As used herein, an exemption refers to a policy allowing for a state of an object to be free from an obligation imposed on other objects in the distributed computing environment. For example, an exemption can allow for a workload to be scaled during a scaling sequence. Exemptions can provide for flexibility when workloads should be scaled or not scaled. For example, workloads which may undergo load testing can be granted an exemption to be scaled. Exemption requests can be received by the computing device, and granted, or rejected, as is further described herein.

The exemption can be a time-based exemption to scale the distributed computing environment for the pod for a predetermined period of time. For example, the exemption can allow the pod to be scaled for two days, and can include the end time for when an exemption is to end (e.g., 48 hours after the pod is scaled).

As previously described in connection with FIG. 1, the distributed computing environment can include an API. The computing device can receive an exemption request to add an exemption for a pod via the API. The exemption request can include information related to the workload for which the exemption is being requested, contact details for the user submitting the exemption request (e.g., team name, project name, business unit, particular user information, etc.), in some examples the length of the exemption, etc. The user may utilize a portal through which an exemption request can be submitted.

In some examples, exemption requests may be automatically granted or rejected. For example, the computing device can automatically grant and generate an exemption in response to the exemption request where the exemption is valid for a predetermined period of time. The predetermined period of time may be, for instance, 2 days. For example, the scaling period (e.g., the period of time between the pod being scaled and descaled) can be 2 days, and the exemption can be automatically granted so that the computing device generates the exemption that is valid for 2 days. Accordingly, the computing device can save the generated exemption in a database (e.g., a PostgreSQL database), such as database 110 previously described in connection with FIG. 1.

In some examples, the computing device can automatically deny an exemption in response to the exemption request. For example, the exemption request may include a request for exemption for a workload having received a previous exemption within a specified time period. For instance, the workload may have already received an exemption in the past week. In such an example, the computing device can automatically deny the exemption request.

Although exemption requests are described above as being automatically granted or denied, embodiments are not so limited. In some examples, the computing device can receive an exemption request and a user can review the exemption request. The computing device can receive a user input approving the exemption request or denying the exemption request. In response to the user input approving the exemption request, the computing device can save the exemption in the PostgreSQL database. However, in response to the user input denying the exemption request, the computing device can delete the exemption request.

Accordingly, at 224, the computing device can poll the PostgreSQL database to determine whether an exemption exists for the workload. At 226, the computing device can determine whether to scale the distributed computing environment for the workload based on the status of the pod and whether an exemption exists for the workload.

In some examples, if the status of the pod indicates the resource usage of the pod does not exceed a threshold, the computing device can refrain from scaling the distributed computing environment. For example, as mentioned above, the computing device can determine the resource usage of the pod to be 1 CPU and 260 MiB. The threshold resource usage may be 300 MiB. Accordingly, the computing device can determine the resource usage for the pod does not exceed the threshold resource usage and can stop the scaling sequence at 228.

In some examples, if an exemption for the workload does not exist in the PostgreSQL Database, the computing device can refrain from scaling the distributed computing environment. For example, as mentioned above, the computing device can poll the PostgreSQL database to determine whether the pod has an exemption associated therewith. In response to the computing device not locating an exemption in the PostgreSQL database, the computing device can determine the resource usage for the pod does not exceed the threshold resource usage and can stop the scaling sequence at 228. In such an example, the computing device can further synchronize the annotation of the pod to indicate the exempt status (e.g., not exempt).

However, at 230, the method includes scaling the distributed computing environment for the workload based on the status of the pod and/or whether the exemption exists for the workload. For instance, the computing device can scale the distributed computing environment in response to the resource usage of the pod exceeding a threshold and/or the exemption for the workload existing in the PostgreSQL database. For example, the computing device can determine the resource usage of the pod to be 1 CPU and 260 MiB, where the threshold resource usage may be 250 MiB, and/or the exemption for the workload existing in the PostgreSQL database. Accordingly, the computing device can scale the distributed computing environment for the workload, as is further described herein.

The computing device can scale the distributed computing environment for the workload by creating a number of replicas of the pod to additionally run the workload. A replica can be a copy of a pod. For example, the workload prior to scaling may utilize one pod, and the computing device can scale the distributed computing environment by creating a copy of the pod so that the workload may utilize two pods to run the workload. Accordingly, the creation of a replica pod can allow for additional computing resources to be utilized by the workload.

While the computing device is described above as creating one replica, embodiments are not so limited. For example, the computing device can create more than one replica, and can create as many replicas as the maximum number of replicas allowed for an exemption for the pod (e.g., 8), as provided for in the annotation of the pod.

As mentioned above, the exemption can be a time-based exemption. Accordingly the plurality of replicas can be created to run the workload for a predetermined period of time. For example, the flight management system running as the workload can utilize the original pod and the replica pod for 2 days. Continuing with the example from FIG. 1, the flight management system can accordingly be load tested using the pod and the replica pod for the two days while the distributed computing environment is scaled.

At 232, the method includes synchronizing an annotation associated with the pod with the annotation information in the PostgreSQL database. Synchronizing the annotation associated with the pod can include comparing the annotation with the annotation information in the PostgreSQL database. For example, the annotation attached to the pod can include the exempt status of the pod as “not exempt”, a maximum number of replicas for an exemption for the pod as “8”, a period of time for the exemption for the pod as “2 days”, and the contact information for the user associated with the pod; the annotation in the PostgreSQL database can include the exempt status of the pod as “exempt”, a maximum number of replicas for an exemption for the pod as “10”, a period of time for the exemption for the pod as “2 days”, and the contact information for the user associated with the pod.

As can be seen, the computing device can determine that the exempt status of the pod is not exempt and maximum number of replicas for the exemption are indicated as 8 in the annotation attached to the pod, but the exempt status is listed as exempt and the maximum number of replicas for the exemption are indicated as 10 in the PostgreSQL database. Accordingly, at 234, the computing device can update the PostgreSQL database to indicate the exempt status as exempt and the maximum number of replicas for the exemption as 8 in the PostgreSQL database. At 236, the computing device can determine whether any discrepancies exist between the annotation attached to the pod and the annotation information in the database, and at 228, the computing device can stop the scaling sequence.

In some examples, however, the annotation attached to the pod can include the exempt status of the pod as “not exempt”, a maximum number of replicas for an exemption for the pod as “8”, a period of time for the exemption for the pod as “5 days”, and the contact information for the user associated with the pod; the annotation in the PostgreSQL database can include the exempt status of the pod as “exempt”, a maximum number of replicas for an exemption for the pod as “8”, a period of time for the exemption for the pod as “2 days”, and the contact information for the user associated with the pod.

In this example, the computing device can determine that the period of time for the exemption for the pod is listed in the annotation as 5 days but the period of time for the exemption for the pod is listed in the PostgreSQL database as 2 days. Accordingly, at 236, the computing device can determine a discrepancy exists between the pod annotation and the annotation information in the PostgreSQL database. This discrepancy may indicate tampering of the annotation of the pod. In this way, the PostgreSQL Database can act as the source of truth in the distributed computing environment. Accordingly, the synchronization of the pod annotation with the annotation information in the PostgreSQL database can detect any tampering that may occur in the distributed computing environment.

In response to a discrepancy existing between the annotation of the pod and the annotation information in the PostgreSQL database, the computing device can save the discrepancy in the PostgreSQL database and can generate and transmit a notification. The notification can be transmitted to a mobile device, a remote computing device, etc. in order to alert a user, such as an administrator, that the discrepancy was detected. Such a notification can, in some examples, include a severity level to indicate to the user that the notification is a high priority alert. The notification can inform the user the discrepancy was detected and the severity level can inform the user regarding the high-priority to address the discrepancy. In the example in which no discrepancy is found, the computing device may not generate a notification. At 228, the computing device can stop the scaling sequence.

Although not illustrated in FIG. 2, the method can further include descaling, by the computing device, the distributed computing environment. For example, after the predetermined period of time expires, the computing device can descale the distributed computing environment by removing the number of replicas. For instance, after the 2 day period expires for the flight management system running as the workload on the pod, the computing device can descale the distributed computing environment by removing (e.g., deleting) the replica pod. Accordingly, the workload can go back to running solely on the pod.

Although a single workload in the distributed computing environment is described above as being scaled for a predetermined period of time, embodiments are not so limited. For example, the methods described herein may be applied to scale multiple workloads within a distributed computing environment.

FIG. 3 is an example of a method for scaling management in a distributed computing environment, in accordance with one or more embodiments. The method can be performed by, for example, computing device 108 of the distributed computing environment, previously described in connection with FIG. 1.

At 352, the computing device can monitor a pod in a distributed computing environment. A user may, for instance at 350, submit a request to add an exemption for the pod, which can be a new event. The computing device can receive the request to add the exemption via an API (e.g., API 112 previously described in connection with FIG. 1). The exemption can be stored in a database 310 (e.g., database 110 previously described in connection with FIG. 1).

At 354, the computing device can cause a scaling sequence to occur (e.g., to perform scaling actions) to scale a workload in the distributed computing environment. As part of the scaling sequence, the computing device can determine a status of the pod by determining a resource usage of the pod for the workload, determining a deployment of the pod, a stateful set of the pod, and/or a deployment configuration of the pod, and checking an annotation associated with the pod. Checking the annotation can include determining an exempt status of the pod, a maximum replicas allowed for an exemption for the pod, a period of time for an exemption for the pod, and/or contact information for a user associated with the pod.

The computing device can additionally determine whether an exemption exists for the workload. For example, the computing device can poll the database 310 to retrieve exemptions to determine whether an exemption exists for the workload.

The computing device can scale the distributed computing environment for the workload based on the status of the pod and whether the exemption exists for the workload. For example, the computing device can scale the distributed computing environment based on the status of the pod indicating a resource usage of the pod exceeds a threshold and/or the exemption for the workload existing in the database 310. Scaling the distributed computing environment can include creating a number of replicas of the pod to additionally run the workload.

However, in response to the status of the pod indicating a resource usage of the pod does not exceed a threshold, the computing device can refrain from scaling the distributed computing environment. In response to the exemption not existing in the database 310, the computing device can refrain from scaling the distributed computing environment.

The exemption can be a time-based exemption. Accordingly, the computing device can scale the distributed computing environment for a predetermined period of time, such as 2 days.

At 356, the computing device can synchronize an annotation associated with the pod with annotation information in a database 360. The computing device can synchronize the annotation by comparing the annotation associated with the pod with annotation information in the database 360. In response to any discrepancy existing between the annotation associated with the pod and the annotation information in the database 360, the computing device can transmit a notification.

Although FIG. 3 illustrates multiple databases 310 and 360, embodiments are not so limited. For example, a single database 310 can exist within the distributed computing environment for scaling management as previously described herein.

In some examples, the computing device can update annotations in the database 310 in response to a discrepancy existing between the annotation associated with the pod and the annotation information in the database 310. For example, the computing device can determine that the exempt status of the pod is not exempt and maximum number of replicas for the exemption are indicated as 8 in the annotation attached to the pod, but the exempt status is listed as exempt and the maximum number of replicas for the exemption are indicated as 10 in the database 310. Accordingly, the computing device can update the database 310 to indicate the exempt status as exempt and the maximum number of replicas for the exemption as 8 in the database 310.

An additional example of a workload executing in a distributed computing environment may include data processing for security systems for a building that is executing on a pod. For example, the security systems may include sensors that generate data and transmit the data to the pod for processing and/or analysis. Such data may come from, for instance, CCTV, intrusion, and/or access sensors, among other types of security sensors.

In some instances, the building may host an event which may correlate with an increase in the amount of data generated and transmitted by such sensors from the building security system. Such an application can be provided with additional computing resources to handle the increase in data utilizing scaling management in a distributed computing environment as described herein.

For example, a computing device can start a scaling sequence to determine whether to scale the distributed computing environment for the security system data processing application executing in the distributed computing environment. The computing device can determine a status of a pod running the security system data processing application by determining a resource usage of the pod (e.g., such as CPU and memory usage), checking an annotation associated with the pod, and determining a deployment of the pod, stateful set of the pod, and/or a deployment configuration of the pod.

Checking the annotation associated with the pod can include determining an exempt status of the pod, a maximum number of replicas allowed for an exemption for the pod, a period of time for an exemption for the pod, and/or contact information for a user associated with the pod. In order to receive an exemption so that the distributed computing environment can be scaled for the security system data processing application, a user associated with the security system data processing application can submit an exemption request. The exemption can be a time-based exemption to scale the distributed computing environment for the pod for a predetermined period of time. For example, the exemption request can include a request to scale the distributed computing environment for the security system data processing application for two days in order to provide the security system data processing application with computing resources to handle data handled by the security system data processing application during the event hosted by the building.

The computing device can determine, as part of the scaling sequence, whether an exemption exists for the security system data processing application. The computing device can poll a PostgreSQL database to determine whether the exemption exists for the security system data processing application. If an exemption does not exist, the computing device can stop the scaling sequence.

However, if an exemption does exist for the security system data processing application, the computing device can scale the distributed computing environment for the security system data processing application in response to the resource usage of the pod exceeding a threshold and/or the exemption for the security system data processing application existing in the PostgreSQL database. Scaling the distributed computing environment can include creating a number of replicas of the pod running the security system data processing application to additionally run the security system data processing application.

As mentioned above, the exemption can be a time-based exemption so that the distributed computing environment can be scaled for a predetermined period of time. Accordingly, the distributed computing environment can be scaled for two days in order to provide sufficient computing resources for the security system data processing application during the building event, which may have a use for heightened security procedures.

As part of the scaling sequence, the computing device can further synchronize an annotation associated with the pod running the security system data processing application with annotation information in the PostgreSQL database. The computing device can synchronize annotations by comparing the annotation associated with the pod running the security system data processing application with the annotation information in the PostgreSQL database to determine whether any discrepancies exist. If any discrepancies do exist, the computing device can stop the scaling sequence, as any discrepancies may indicate tampering of the annotation of the pod. Further, the computing device can generate and transmit an alert if a discrepancy is detected.

Upon expiration of the predetermined period of time for the exemption, the computing device can descale the distributed computing environment by removing the number of replicas created for the security system data processing application. Accordingly, the security system data processing application can go back to running on the previously delegated computing resources in the distributed computing environment.

Another example of a workload executing in a distributed computing environment may include load testing a server for a shopping service that is executing on a pod. For example, an organization may be launching a new online service and it may be useful to load test the database for the service prior to being launched.

A computing device can start a scaling sequence to determine whether to scale the distributed computing environment for the database for the service executing in the distributed computing environment. The computing device can determine a status of a pod running the database for the service by determining a resource usage of the pod (e.g., such as CPU and memory usage), checking an annotation associated with the pod, and determining a deployment of the pod, stateful set of the pod, and/or a deployment configuration of the pod.

Checking the annotation associated with the pod can include determining an exempt status of the pod, a maximum number of replicas allowed for an exemption for the pod, a period of time for an exemption for the pod, and/or contact information for a user associated with the pod. In order to receive an exemption so that the distributed computing environment can be scaled for the database for the service, a user associated with the security system data processing application can submit an exemption request. The exemption can be a time-based exemption to scale the distributed computing environment for the pod for a predetermined period of time. For example, the exemption request can include a request to scale the distributed computing environment for the database for the service for two days in order to provide the security system data processing application with computing resources to handle load testing of the database for the service.

The computing device can determine, as part of the scaling sequence, whether an exemption exists for the database for the service. The computing device can poll a PostgreSQL database to determine whether the exemption exists for the database for the service. If an exemption does not exist, the computing device can stop the scaling sequence.

However, if an exemption does exist for the security system data processing application, the computing device can scale the distributed computing environment for the database for the service in response to the resource usage of the pod exceeding a threshold and/or the exemption for the database for the service existing in the PostgreSQL database. Scaling the distributed computing environment can include creating a number of replicas of the pod running the database for the service to additionally run the database for the service.

As mentioned above, the exemption can be a time-based exemption so that the distributed computing environment can be scaled for a predetermined period of time. Accordingly, the distributed computing environment can be scaled for a day while the load testing occurs in order to provide sufficient computing resources for the database for the service during the load testing.

As part of the scaling sequence, the computing device can further synchronize an annotation associated with the pod running the database for the service with annotation information in the PostgreSQL database. The computing device can synchronize annotations by comparing the annotation associated with the pod running the database for the service with the annotation information in the PostgreSQL database to determine whether any discrepancies exist. If any discrepancies do exist, the computing device can stop the scaling sequence, as any discrepancies may indicate tampering of the annotation of the pod. Further, the computing device can generate and transmit an alert if a discrepancy is detected.

Upon expiration of the predetermined period of time for the exemption, the computing device can descale the distributed computing environment by removing the number of replicas created for the database for the service. Accordingly, the database for the service can go back to running on the previously delegated computing resources in the distributed computing environment.

A further example of a workload executing in a distributed computing environment may include a user requesting additional computing resources in the distributed computing environment for data processing for a research application that is executing on a pod. The research application may be utilized by a small number of employees at an organization and may not be an important business unit in the organization.

A computing device can start a scaling sequence to determine whether to scale the distributed computing environment for the database for the service executing in the distributed computing environment. The computing device can determine a status of a pod running the database for the service by determining a resource usage of the pod (e.g., such as CPU and memory usage), checking an annotation associated with the pod, and determining a deployment of the pod, stateful set of the pod, and/or a deployment configuration of the pod.

Checking the annotation associated with the pod can include determining an exempt status of the pod, a maximum number of replicas allowed for an exemption for the pod, a period of time for an exemption for the pod, and/or contact information for a user associated with the pod. In order to receive an exemption so that the distributed computing environment can be scaled for the database for the service, a user associated with the security system data processing application can submit an exemption request. The exemption request can include a request to scale the distributed computing environment for the research application executing in the distributed computing environment. However, as mentioned above, this research application may not be important and therefore the exemption denied.

The computing device can determine, as part of the scaling sequence, whether the exemption exists for the database for the service. The computing device can poll a PostgreSQL database to determine whether the exemption exists for the database for the service. As the exemption does not exist, the computing device can stop the scaling sequence.

Accordingly, scaling management in a distributed computing environment, as described herein, can allow for efficient scaling of computing resources in a distributed computing environment. The distributed computing environment can be scaled for workloads having time-based exemptions, allowing for such workloads to receive additional computing resources for a specified period of time. The synchronization process can ensure that any tampering within the distributed computing environment is detected and reported. Such an approach can prevent computing resources in the distributed computing environment from being monopolized, ensuring fair resource allocation across the distributed computing environment, preventing computing resource shortages for other workloads. Such an approach can additionally save costs by preventing replicas that are not needed from being created, as compared with previous approaches.

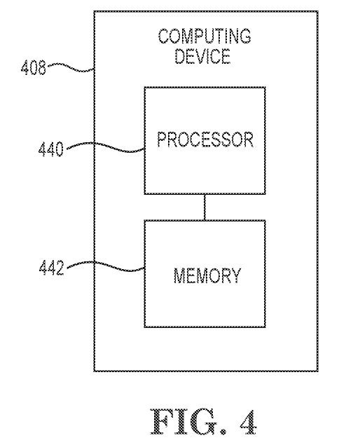

FIG. 4 is an example of a computing device 408 for scaling management in a distributed computing environment, in accordance with one or more embodiments of the present disclosure. As illustrated in FIG. 4, the computing device 408 can include a memory 442 and a processor 440 for scaling management in a distributed computing environment, in accordance with the present disclosure.

The memory 442 can be any type of storage medium that can be accessed by the processor 440 to perform various examples of the present disclosure. For example, the memory 442 can be a non-transitory computer readable medium having computer readable instructions (e.g., executable instructions/computer program instructions) stored thereon that are executable by the processor 440 for scaling management in a distributed computing environment in accordance with the present disclosure.

The memory 442 can be volatile or nonvolatile memory. The memory 442 can also be removable (e.g., portable) memory, or non-removable (e.g., internal) memory. For example, the memory 442 can be random access memory (RAM) (e.g., dynamic random access memory (DRAM) and/or phase change random access memory (PCRAM)), read-only memory (ROM) (e.g., electrically erasable programmable read-only memory (EEPROM) and/or compact-disc read-only memory (CD-ROM)), flash memory, a laser disc, a digital versatile disc (DVD) or other optical storage, and/or a magnetic medium such as magnetic cassettes, tapes, or disks, among other types of memory.

Further, although memory 442 is illustrated as being located within computing device 408, embodiments of the present disclosure are not so limited. For example, memory 442 can also be located internal to another computing resource (e.g., enabling computer readable instructions to be downloaded over the Internet or another wired or wireless connection).

The processor 440 may be a central processing unit (CPU), a semiconductor-based microprocessor, and/or other hardware devices suitable for retrieval and execution of machine-readable instructions stored in the memory 442.

Although specific embodiments have been illustrated and described herein, those of ordinary skill in the art will appreciate that any arrangement calculated to achieve the same techniques can be substituted for the specific embodiments shown. This disclosure is intended to cover any and all adaptations or variations of various embodiments of the disclosure.

It is to be understood that the above description has been made in an illustrative fashion, and not a restrictive one. Combination of the above embodiments, and other embodiments not specifically described herein will be apparent to those of skill in the art upon reviewing the above description.

The scope of the various embodiments of the disclosure includes any other applications in which the above structures and methods are used. Therefore, the scope of various embodiments of the disclosure should be determined with reference to the appended claims, along with the full range of equivalents to which such claims are entitled.

In the foregoing Detailed Description, various features are grouped together in example embodiments illustrated in the figures for the purpose of streamlining the disclosure. This method of disclosure is not to be interpreted as reflecting an intention that the embodiments of the disclosure require more features than are expressly recited in each claim.

Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A method for scaling management in a distributed computing environment, comprising:
determining, by a computing device, a status of a pod running a workload in a distributed computing environment, wherein the pod is an object in the distributed computing environment having a number of containers configured to execute computer-readable instructions to run the workload;
determining, by the computing device, whether an exemption exists for the workload; and
scaling, by the computing device, the distributed computing environment for the workload based on the status of the pod and whether the exemption exists for the workload, wherein scaling the distributed computing environment for the workload includes creating a number of replicas of the pod to additionally run the workload.

2. The method of claim 1, wherein the method includes scaling the distributed computing environment based on:
the status of the pod indicating a resource usage of the pod exceeds a threshold; and
the exemption for the workload existing.

3. The method of claim 1, wherein determining the status of the pod includes determining a resource usage of the pod for the workload.

4. The method of claim 1, wherein determining the status of the pod includes checking an annotation associated with the pod.

5. The method of claim 4, wherein checking the annotation includes determining at least one of:
an exempt status of the pod;
a maximum replicas allowed for an exemption for the pod;
a period of time for an exemption for the pod; and
contact information for a user associated with the pod.

6. The method of claim 1, wherein determining the status of the pod includes determining at least one of a deployment of the pod, a stateful set of the pod, and a deployment configuration of the pod.

7. The method of claim 1, wherein the exemption is a time-based exemption to scale the distributed computing environment for a predetermined period of time.

8. The method of claim 1, wherein the method includes synchronizing an annotation associated with the pod with annotation information in a database in the distributed computing environment.

9. A non-transitory computer readable medium storing instructions executable by a processing resource to cause the processing resource to:
determine a status of a pod running a workload in a distributed computing environment, wherein the pod is an object in the distributed computing environment having a number of containers configured to execute computer-readable instructions to run the workload;
determine whether a time-based exemption exists for the workload; and
scale the distributed computing environment for the workload by creating a number of replicas of the pod to additionally run the workload based on the status of the pod and whether the time-based exemption exists for the workload.

10. The non-transitory computer readable medium of claim 9, wherein the time-based exemption scales the number of replicas for a predetermined period of time.

11. The non-transitory computer readable medium of claim 10, comprising instructions to descale the distributed computing environment by removing the number of replicas after the predetermined period of time expires.

12. The non-transitory computer readable medium of claim 9, comprising instructions to determine whether the time-based exemption exists by polling a database for the time-based exemption.

13. The non-transitory computer readable medium of claim 12, wherein the database is a PostgreSQL database.

14. The non-transitory computer readable medium of claim 9, comprising instructions to refrain from scaling the distributed computing environment for the workload in response to the status of the pod indicating a resource usage of the pod does not exceed a threshold.

15. The non-transitory computer readable medium of claim 9, comprising instructions to refrain from scaling the distributed computing environment for the workload in response to an exemption for the workload not existing in a database.

16. A computing device for scaling management in a distributed computing environment, comprising:
a processing resource; and
a memory resource storing non-transitory machine-readable instructions to cause the processing resource to:
determine a status of a pod running a workload in a distributed computing environment including at least one of a resource usage of the pod and an annotation associated with the pod, wherein the pod is an object in the distributed computing environment having a number of containers configured to execute computer-readable instructions to run the workload;
determine whether an exemption exists for the workload by polling a database; and
scale the distributed computing environment for the workload by creating a number of replicas of the pod according to the annotation associated with the pod in response to the status of the pod and an exemption existing for the workload, wherein the number of replicas are configured to additionally run the workload.

17. The computing device of claim 16, including instructions to cause the processing resource to synchronize the annotation with annotation information in the database by comparing the annotation with the annotation information in the database.

18. The computing device of claim 17, including instructions to cause the processing resource to transmit a notification in response to a discrepancy existing between the annotation and the annotation information in the database.

19. The computing device of claim 16, including instructions to cause the processing resource to receive a request to add an exemption for the pod.

20. The computing device of claim 16, wherein the distributed computing environment is a Kubernetes environment.
